(19) United States
(12) Patent Application Publication
(10) Pub. No.: US 2002/0175148 A1
(43) Pub. Date: Nov. 28, 2002

(54) Process for producing a welded joint

(75) Inventors: Michael Meyer, Burgwedel (DE); Christian Frohne, Hannover (DE); Friedrich Harten, Stadthagen (DE)

Correspondence Address: SUGHRUE MION, PLLC, 2100 Pennsylvania Avenue, NW, Washington, DC, 20037-3213, US

(73) Assignee: NEXANS

(21) Appl. No.: 10/153,700

(22) Filed: May 24, 2002

(30) Foreign Application Priority Data
May 26, 2001 (DE) 10125830.5

(51) Int. Cl. B23K 9/00

(52) U.S. Cl. 219/61; 219/137 R

(57) ABSTRACT

In a process for producing a welded joint between the ends of two metal strips in which the butted ends are connected by means of a TIG welder that can be moved perpendicularly to the longitudinal direction of the metal strips, one sheet metal piece each is placed in the area of the butt joint along the longitudinal sides of the metal strips. The two sheet metal pieces are tack-welded to the longitudinal edges of the metal strips in the joint area by means of a spot weld of the TIG welding unit. The strip ends are welded together by moving the welder along the joint edges. The welder is activated on one of the sheet metal pieces and moved up to the opposite sheet metal piece, and the two sheet metal pieces are removed from the longitudinal sides.

This application is based on and claims the benefit of German Patent Application No. 10125830.5 filed May 26, 2001, which is incorporated by reference herein.

### BACKGROUND OF THE INVENTION

The invention relates to a process for producing a welded joint between the ends of two metal strips in accordance with the preamble of claim 1 and to the use of said process to produce longitudinally welded tubes.

In the production of longitudinally welded tubes, a metal strip is paid off from a supply reel, possibly cleaned, trimmed along the strip edges, formed into an open seam tube, and longitudinally welded. The length that can be produced in this manner is limited by the length of the metal strip on the supply reel. On the other hand, the length of the metal tube is limited by the capacity of the take-up drum for the metal tube.

If the length of the metal strip on the supply reel differs from the capacity of the drum, the result is that either the metal tube is short or a relatively long piece of metal strip is scrap.

Thus, in a continuous tube production line, the practice has been to join by a transverse weld seam the end of the metal strip that is in the production line and the starting end of a subsequent metal strip. A so-called strip accumulator takes up a sufficient strip supply that production does not need to be interrupted.

The transverse weld seam was produced either by laser welding or by inert gas arc welding. A laser welding unit is significantly more expensive than an arc welding unit. Moreover, laser welding is problematic for strongly reflective metals, such as copper.

The problem with using an electric arc welder to produce a transverse weld seam is that fusion penetration along the strip edges may cause holes to form at the start and at the end of the weld. This problem occurs particularly in welds that extend at a 30° to 45° angle to the longitudinal direction of the metal strip, since the heat acting on the taper cut sheet metal is so great that the metal melts away.

It has been attempted to solve this problem by working with a filler wire or by folding the edge of a metal strip and using the edge as the filler material. The drawback, however, is that the weld seam has to be processed.

Another solution is to trim the metal strip more widely along its longitudinal edges, which causes more strip material to be scrapped. (International Uniwema Licensee Conference of Kabel- und Metallwerke Gutehoffnungshütte AG in Hannover, November 16 to 17, 1967).

### SUMMARY OF THE INVENTION

The object of the present invention is to provide a process for producing a transverse weld that overcomes the drawbacks of the prior art processes.

This object is attained in a surprisingly simple manner by the characterizing features set forth in claim 1.

The essential advantage of the invention is that tack welding of the pieces of sheet metal prevents air gaps that are detrimental to arc welding between the metal strips and the sheet metal pieces, so that holes caused by fusion penetration no longer occur. The new process is significantly faster than prior art processes.

### BRIEF DESCRIPTION OF THE DRAWINGS

The invention will now be described in greater detail with reference to the exemplary embodiments schematically depicted in FIGS. 1 and 2.

FIG. 1 shows a side elevation of a tube manufacturing line.

### DETAILED DESCRIPTION OF THE INVENTION

1 designates a metal strip, e.g. with a wall thickness of 0.3 mm and a width of 30 mm, which is formed into an open seam tube in a tube forming apparatus 2. The longitudinal open seam of the metal strip 1 that has been formed into a tube is seal-welded with an arc welder 3. The welded tube is grasped by a withdrawal unit 4, which feeds the welded tube to a take-up device 5.

To enable tubes to be manufactured almost without interruption in such a line, the starting end of a new strip supply 6 is welded to the end of the metal strip 1 that is in production. For this purpose, a sufficient supply of metal strip 1 is drawn into a strip accumulator 7, and the end of metal strip 1 is then clamped and cut by a cutter (not depicted). The start of the new metal strip 1a is also cut, so that the two ends meet. The cuts of the strip ends preferably extend at a 45° angle to the longitudinal axis of the metal strip 1. This increases the ability of the transverse weld to withstand tensile loads.

The transverse seam is welded with an electric arc welder 8.

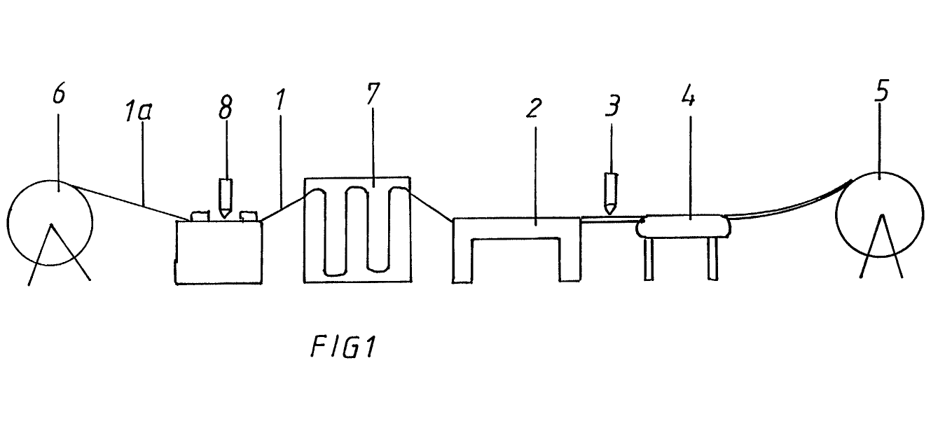

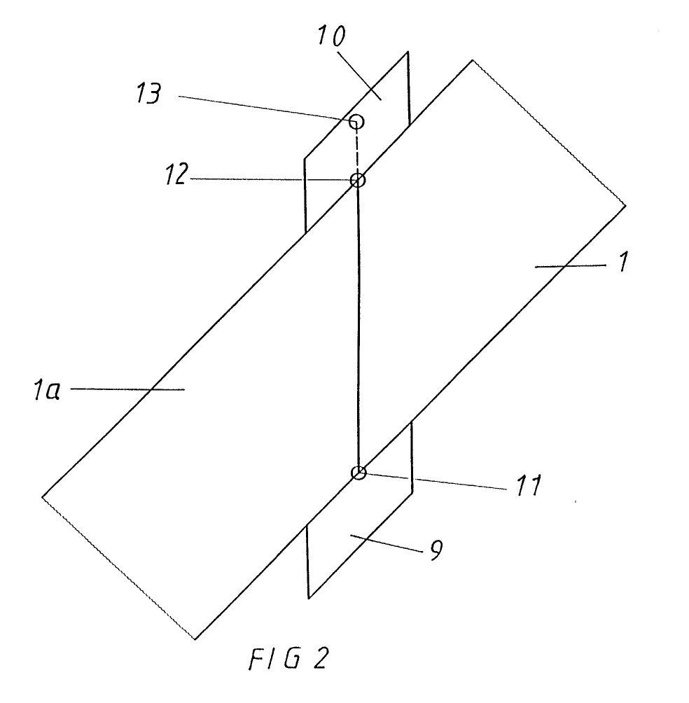

The preliminary work and the actual welding process will now be described in greater detail with reference to FIG. 2. After the ends of the metal strips 1 and 1a have been cut at an approximately 45° angle to the longitudinal axis, sheet metal pieces 9 and 10 are placed tightly against the longitudinal edges of the metal strips 1 and 1a in the area of their butt edges. The sheet metal pieces 9 and 10 are made of the same material as the metal strips 1 and 1a. Thereafter, an arc welder identified as 8 in FIG. 1 [not shown] is used to tack-weld the sheet metal pieces 9 and 10 at points 11 and 12. The arc welder 8 is then moved to point 13 where it is activated and via points 12 and 11 is moved to metal piece 9 to form a weld seam between the metal strips 1 and 1a. Finally, the sheet metal pieces 9 and 10 are removed from the metal strips 1 and 1a by bending.

The clamping devices can now be detached and after emptying the accumulator 7, the new metal strip 1a can be pulled into the line.

What is claimed is:

1. A process for producing a weld connection between the ends of two metal strips in which the butted ends are joined by means of a TIG welder that is displaceable perpendicularly to the longitudinal direction of the metal strips, said process comprising the steps of:
a) placing sheet metal pieces against longitudinal sides of the metal strip in the area of the butt joint,
b) tacking the two sheet metal pieces with a spot weld of the TIG welder to the longitudinal edges of the metal strips in the area of the butt joint,
c) welding the strip ends together by moving the welder along the butt joint, with the welder being activated on one of the sheet metal pieces and moved to the opposite sheet metal piece, and
d) removing the two sheet metal pieces from the longitudinal sides.

2. A process as claimed in claim 1, wherein the ends of the metal strips are welded together at an angle of between 15° and 45° to the longitudinal axis of the metal strips.

3. A process as claimed in claim 1, wherein the sheet metal pieces are made of the same material as the metal strips.

4. Use of the process as claimed in claim 1 to produce longitudinally welded metal tubes, wherein joining of the ends of the metal strips takes place in tandem with the tube forming and longitudinal welding process.

5. Use as claimed in claim 4, wherein the metal strip is stored in an accumulator between the welding of the strip ends and the tube production process.
